(19) United States
(12) Patent Application Publication
(10) Pub. No.: US 2013/0297513 A1
(43) Pub. Date: Nov. 7, 2013

(54) MULTI FACTOR USER AUTHENTICATION

(71) Applicants: Viacheslav Kirillin, Sankt-Petersburg (RU); Sergey Zemlyanskiy, Sankt-Petersburg (RU); Dimitry A. Baranov, Moscow (RU); Vladimir Podoshvin, Sankt-Petersburg (RU)

(72) Inventors: Viacheslav Kirillin, Sankt-Petersburg (RU); Sergey Zemlyanskiy, Sankt-Petersburg (RU); Dimitry A. Baranov, Moscow (RU); Vladimir Podoshvin, Sankt-Petersburg (RU)

(73) Assignee: RAWLLIN INTERNATIONAL INC., Tortola (BV)

(21) Appl. No.: 13/464,504

(22) Filed: May 4, 2012

(51) Int. Cl. G06Q 20/40

(52) U.S. Cl. 705/67

(57) ABSTRACT

Technologies are generally described for multi factor security authentication algorithm methods in authorizing and using client devices to perform banking transactions. A customer can register and associate a client device with their account. The customer can further create unique login information associated with their account. A customer's login information, client device, and a push confirmation must be verified for accuracy prior to allowing the customer to perform banking operations. Using multi factor authentication process, banking transactions can be performed more reliably and securely.

### TECHNICAL FIELD

This application relates to banking, and more particularly to security algorithms associated with multi factor user authentication.

### BACKGROUND

Consumer and business demand for online services has greatly increased in recent years. This is also true in the banking industry where customers expect access to their accounts to both gather information and to perform banking operations. As the desire for online service has grown, so too has the number of internet connected devices. For example, some customers may have a computer at their place of occupation, a computer in a home office, a smart phone capable of connecting to the internet, a tablet computer, etc. Customer expectations are that they be able to access their accounts on any of the myriad of devices they may use to connect to internet services.

With customer expectations demanding multiple device connectivity, detecting fraudulent access to a customer's accounts becomes more complex. Creating an online hub for customers to access their accounts necessarily involves creating a public portal capable of granting a plurality of customers' access to their accounts. This public portal is also capable of being accessed by those without accounts such as those seeking to fraudulently access a customer's account. One way of preventing such fraudulent access is through restricting account access to authenticated users and restricting the performance of banking operations to those who have passed a multi factor authentication process. However, protocols must be established to prevent improper access to bank accounts and improper performance of banking operations.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its sole purpose is to present some concepts of the specification in a simplified form as a prelude to the more detailed description that is presented in this disclosure.

Systems and methods disclosed herein relate to authenticated banking transactions. A communications component can at least one of send or receive data packets to or from a client device. A user authentication component can receive and authenticate login information from a client device. A push component can, upon authentication of the login information, send a push notification to a linked device associated with the login information. A device authentication component can receive and authenticate a device certificate and a device token from the client device. A push authentication component can receive and authenticate a push confirmation from the client device. If the login information, the device certificate, and the push confirmation are authenticated, the client device can be authorized to perform banking transactions.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 illustrates an example high level flow diagram method for authenticating a customer using an authorized device;

FIG. 2 illustrates an example high level flow diagram method for authenticating a customer using an unauthorized device;

FIG. 3 illustrates an example flow diagram method for device registration;

FIG. 4 illustrates an example flow diagram method for authenticating a customer using an unauthorized device;

FIG. 5A illustrates an example flow diagram method for authenticating a customer using an authorized device with a valid device token;

FIG. 5B illustrates an example flow diagram method for authenticating a customer using an authorized device with an invalid device token;

FIG. 6 illustrates an example flow diagram method for performing banking operations using an authorized device;

FIG. 7 illustrates an example flow diagram method for performing banking operations using an unauthorized device;

FIG. 8 illustrates an example flow diagram method for authenticating a customer;

FIG. 9 illustrates an example flow diagram method for authenticating a customer with either a valid or an invalid device token;

FIG. 10 illustrates an example secure banking system in accordance with the subject disclosure;

FIG. 11 illustrates an example secure banking system including a data storage component in accordance with the subject disclosure;

FIG. 12 illustrates an example secure banking system including a banking operations component in accordance with the subject disclosure;

FIG. 13 illustrates an example secure banking system including a banking operations authentication component in accordance with the subject disclosure;

FIG. 14 illustrates an example client device in accordance with the subject disclosure

FIG. 15 illustrates an example schematic block diagram for a computing environment in accordance with the subject specification; and

FIG. 16 illustrates an example block diagram of a computer operable to execute the disclosed architecture.

### DETAILED DESCRIPTION

The various embodiments are now described with reference to the drawings, wherein like reference numerals are used to refer to like elements throughout. In the following description, for purposes of explanation, numerous specific details are set forth in order to provide a thorough understanding of the various embodiments. It may be evident, however, that the various embodiments can be practiced without these specific details. In other instances, well-known structures and devices are shown in block diagram form in order to facilitate describing the various embodiments.

The architecture disclosure herein can be based on a multi-factor authentication process for banking operations. Operations can be performed over hyper text transfer protocol secure (“HTTPS”) which provides server authentication and data confidentiality between a client and a server. In the first factor, customers can be authenticated using unique login information. In a second factor, a device certificate installed on an authorized client device can be verified for accuracy. In a third factor, a device token of an authorized user device can be sent by a push notification server to the authorized client device. Through the use of a device token sent by a push notification server, it can be ensured that authentication will fail even if a fraudulent user copies the device certificate residing in the authorized client device into an unauthorized client device, as the device token sent by the push notification server will be sent strictly to an authorized device.

A customer can login from an authorized device, a client device containing a device certificate stored within the client device memory, or from an unauthorized device, a client device without a device certificate stored within memory. Performance of banking operations is allowed using authorized client devices. Unauthorized client devices can be used to see account balances only. Performance of banking transactions initiated from an unauthorized device must be confirmed from an authorized client device associated with the customer account prior to performance of the banking transaction. Authorized devices use transport layer security protocols for client authentication while unauthorized devices use standard secure sockets layer protocol.

In one implementation, one time passwords can be generated and used to activate a client device to use digital certificates in accordance with various implementations in the subject disclosure. For example, a random string of letters and numbers can be generated by a password component. The password component can be adjusted by an administrator the like to adjust the types of characters used or length of a generated password. The password component can reside on a bank server and also generate a random number (“RAND”) upon request.

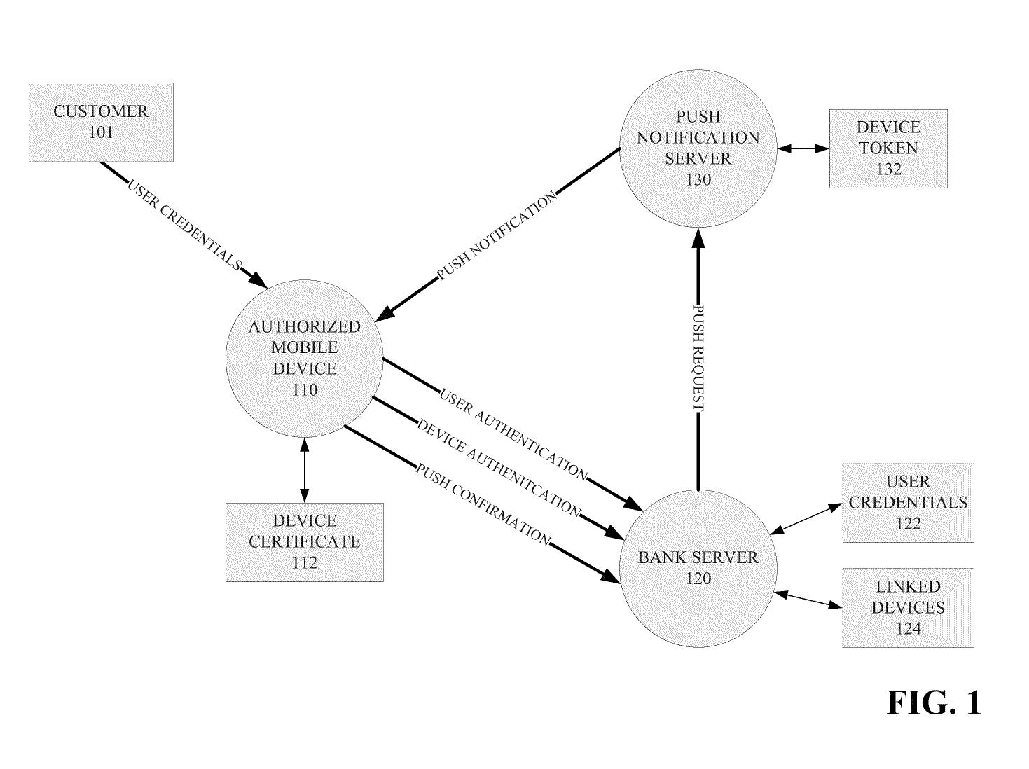

FIGS. 1-9 illustrate methods and/or flow diagrams in accordance with this disclosure. For simplicity of explanation, the methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Referring now to FIG. 1, there is illustrated an example high level flow diagram method for authenticating a customer using an authorized mobile device 110. Customer 101 can submit user credentials to the authorized mobile device 110. For example, authorized mobile device 110 can display a form for entry of user credentials wherein customer 101 can submit user credentials. User credentials can include a username, a password, a personal identification number (“PIN”), answers to security questions, etc. User credentials can be submitted to bank server 120 as a part of user authentication. Bank server 120 can compare the user credentials submitted by authorized mobile device 110 to user credentials 122 stored in a data store accessible by bank server 120.

In response to authenticating the user credentials of customer 101, bank server 120 can send a push request to push notification server 130. As a part of the push request, bank server 120 can send identification information to push notification server regarding customer 101. Push notification server 130 can access device tokens 132 related to a plurality of authorized mobile devices and identify a device token associated with authorized mobile device. Push notification server 130 can send a device token 132 related to authorized mobile device 110 to authorized mobile device 110. In an alternate embodiment, push notification server 130 can send a device token related to authorized mobile device 110 based on a request by authorized mobile device 110 to push notification server 130. Push notification server 130 can also send a push notification to authorized mobile device 110 referencing the push request made by bank server 120.

Authorized mobile device 110 can store a device certificate 112 in its memory. As a part of device authentication, authorized mobile device 110 can send the device certificate 112 stored in memory of the authorized mobile device 110 along with a device token received from push notification server 130 to bank server 120. Bank server 120 can then authenticate the authorized mobile device 110 using the device certificate and device token by comparing the device certificate and device token to linked device information 124 accessible in a data store by bank server 120.

Authorized mobile device 110 can also send the push notification received from push notification server 130, e.g., a push confirmation, to bank server 120. Bank server 120 can compare the push confirmation to the push request previously sent to push notification server 130 for accuracy.

Bank server 120 can then use a multifactor authentication process analyzing three distinct factors: user authentication, device authentication, and push confirmation. If bank server 120 authenticates the user, the device, and the push confirmation, customer 101 can be authorized to use authorized mobile device 110 to perform banking operations.

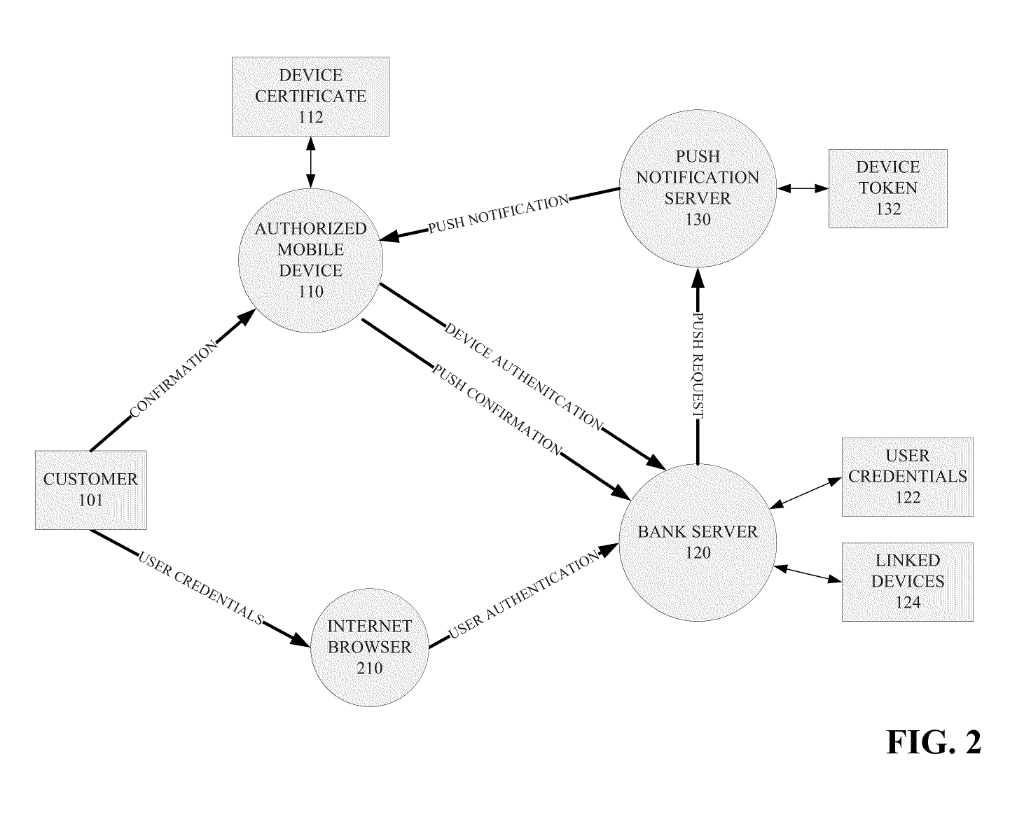

Referring now to FIG. 2, there is illustrated an example high level flow diagram method for authenticating a customer using an unauthorized device. Customer 101 can submit user credentials to an unauthorized device using an internet browser 210. It can be appreciated that a separate software application could be used in place of an internet browser, and an internet browser is only used as an example. For further example, internet browser 210 can display a form for entry of user credentials wherein customer 101 can submit user credentials. User credentials can include a username, a password, a personal identification number (“PIN”), answers to security questions, etc. User credentials can be submitted to bank server 120 as a part of user authentication. Bank server 120 can compare the user credentials submitted by internet browser 210 to user credentials 122 stored in a data store accessible by bank server 120.

In response to authenticating the user credentials of customer 101, bank server 120 can send a push request to push notification server 130. As a part of the push request, bank server 120 can send identification information to push notification server regarding customer 101. Push notification server 130 can access device tokens 132 related to a plurality of authorized mobile devices and identify a device token associated with authorized mobile device. Push notification server 130 can send a device token 132 related to authorized mobile device 110 to authorized mobile device 110. In an alternate embodiment, push notification server 130 can send a device token related to authorized mobile device 110 based on a request by authorized mobile device 110 to push notification server 130. Push notification server 130 can also send a push notification to authorized mobile device 110 referencing the push request made by bank server 120.

Authorized mobile device 110 can store a device certificate 112 in its memory. As a part of device authentication, Customer 101 can confirm to authorized mobile device 110 that it wishes to confirm their identity. Authorized mobile device 110 can send the device certificate 112 stored in memory of the authorized mobile device 110 along with a device token received from push notification server 130 to bank server 120. Bank server 120 can then authenticate the authorized mobile device 110 using the device certificate and device token by comparing the device certificate and device token to linked device information 124 accessible in a data store by bank server 120.

In further response to Customer 101 confirming to authorized mobile device 110 that it wishes to confirm their identity, authorized mobile device 110 can also send the push notification received from push notification server 130, e.g., a push confirmation, to bank server 120. Bank server 120 can compare the push confirmation to the push request previously sent to push notification server 130 for accuracy.

Bank server 120 can then use a multifactor authentication process analyzing three distinct factors: user authentication, device authentication, and push confirmation. If bank server 120 authenticates the user, the device, and the push confirmation, customer 101 can be authorized to use internet browser 210 to perform banking operations.

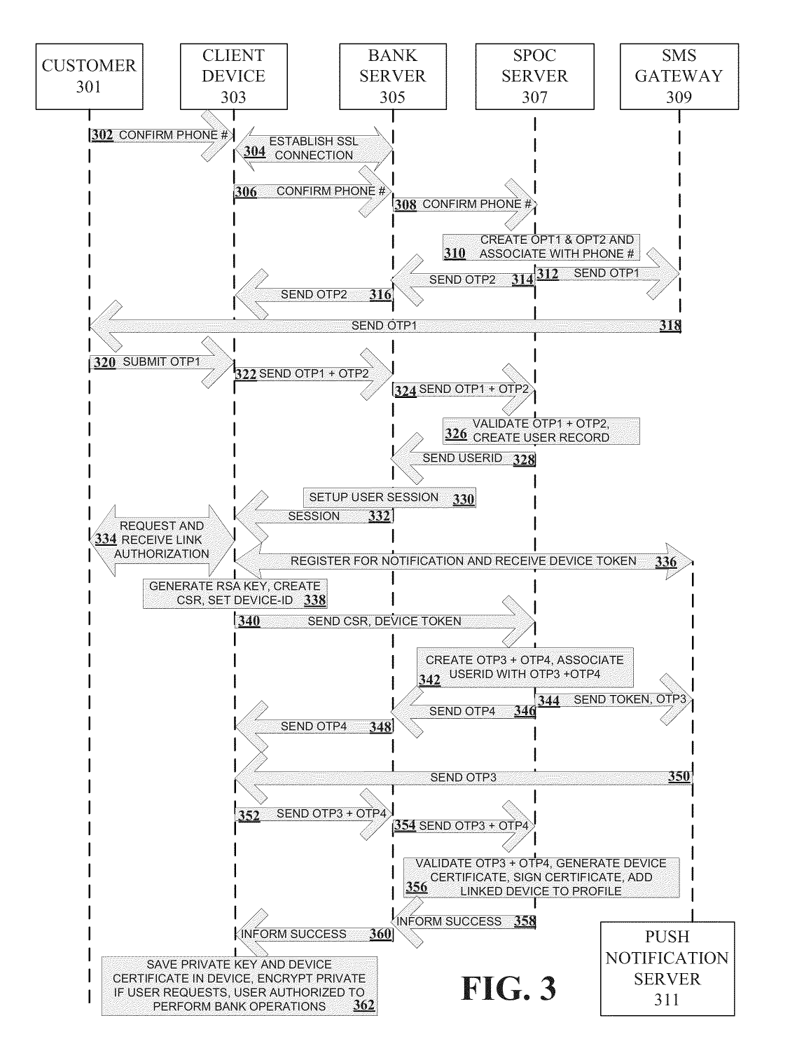

Referring now to FIG. 3, there is illustrated an example flow diagram method for device registration. At 302, a customer 301 can submit a phone number associated with a mobile device it wishes to register to client device 303. At 304, client device 303 can establish a secure connection with bank server 305 using, for example, a secure sockets layer (“SSL”) protocol or a transport layer security (“TLS”) protocol. At 306, client device 303 can send the phone number submitted by customer at 302 to bank server 305. Bank server 305 can then send the phone number to a SPOC server 307. At 310, SPOC server 307 can generate a first one time password (“OTP1”) and a second one time password (“OTP2”) for phone validation, and associate the phone number submitted at 308 with OTP1 and OTP2.

At 312, SPOC server 307 can send OTP1, the phone number submitted at 308 to a short message service (“SMS”) gateway 309 where an SMS gateway is a telecommunications network facility for sending or receiving SMS transmissions to or from a telecommunications network that supports SMS. At 414, SPOC server 307 can send OTP2 to bank server 305. At 316, bank server 305 can send OTP2 to client device 303. At 318, SMS gateway 309 can send OTP1 via SMS text message to the phone number submitted at 312.

At 320, customer 301 can submit a password for an account, a phone number, and OTP1 received via SMS text message at 318 to client device 303. Client device 303 can submit OTP2 received at 316, OTP1, the phone number, and the password submitted by customer 301 at 320 to bank server 305. Banks server 305 can send the phone number, password, OTP1, and OTP2 to SPOC server 307. At 326, SPOC server 307 can validate OTP1 and OTP2 for accuracy in that they match the OTP1 and OTP2 generated at 310. If OTP1 or OTP2 submitted at 324 do not match the OTP1 and OTP2 generated at 310, customer 301 can be informed of a failure to register the device. If OTP1 or OTP2, submitted at 324, match the OTP1 and OTP2 generated at 310, a new user record can be created which can include a user id and the phone number and password submitted by customer 301 at 320.

At 328, the user id created at 324 can be sent to bank server 305. At 330, bank server 305 can establish a user session with a session id, generate a random number (“RAND”) to prevent a replay of the session as a client accessing the session would need to know RAND. RAND can then be assigned to the session id. At 332, the session id and RAND can be sent to client device 303. At this point, customer 301 can see the balance of any account he or she holds, but cannot perform banking operations.

At 334, Client device 303 can display a request to customer 301 asking the customer 301 whether they desire to register or link client device 303 to their user id. If customer 301 responds no, then customer 301 continues to only be able to see his or her account balances and cannot perform banking operations. If customer 301 responds yes, then registration continues.

At 336, client device 303 can register for notifications with SMS gateway 309 and in response receive a device token from SMS gateway 309. At 338, client device 303 can generate an RSA key pair for device authentication, create a certificate signing request, and set a device id to a unique device number. At 340, client device 303 can send the session id, the certificate signing request, and the device token to bank server 305 which can then pass on the user id, the certificate signing request, and the device token to SPOC server 307.

At 342, SPOC server 307 can generate a third one time password (“OTP3) and a fourth one time password (“OTP4”). OTP3 and OTP4 can be associated with the user id and certificate signing request. At 344, SPOC server 307 can send the device token, and OTP3 to a push notification server 311. Push notification server 311 can store the device token in an associated data store and associate it with client device 303. At 346, SPOC server 307 can send OTP4 to bank server 305. At 348, bank server 305 can send OTP4 to client device 303. At 350, push notification server 311 can send a push notification which includes OTP3 to client device 303.

At 352, client device 303 can send OTP3, OTP4, and the session id to bank server 305. At 354, bank server 305 can send the user id, OTP3 and OTP4 to SPOC server 307. At 356, SPOC server 307 can validate the user id, OTP3, and OTP4. If the user id, OTP3 and OTP4 fail validation, then customer 301 can be informed of the failure and customer 301 continues to only be able to see his or her account balances and cannot perform banking operations. If the user id, OTP3 and OTP4 pass validation, then a device certificate can be generated based on the certificate signing request, by signing the certificate against the server root certificate to support TLS with client authentication. The user id, device id, and device token can then be added to the user record generated at 326. At 358, the device certificate can be sent to bank server 305. At 360, the device certificate can be sent to client device 303. At 362, a private key and the device certificate can be saved into memory of the client device 303. The private key can be encrypted if customer 301 requests password protection of payment operations. The customer is then authorized to perform banking operations.

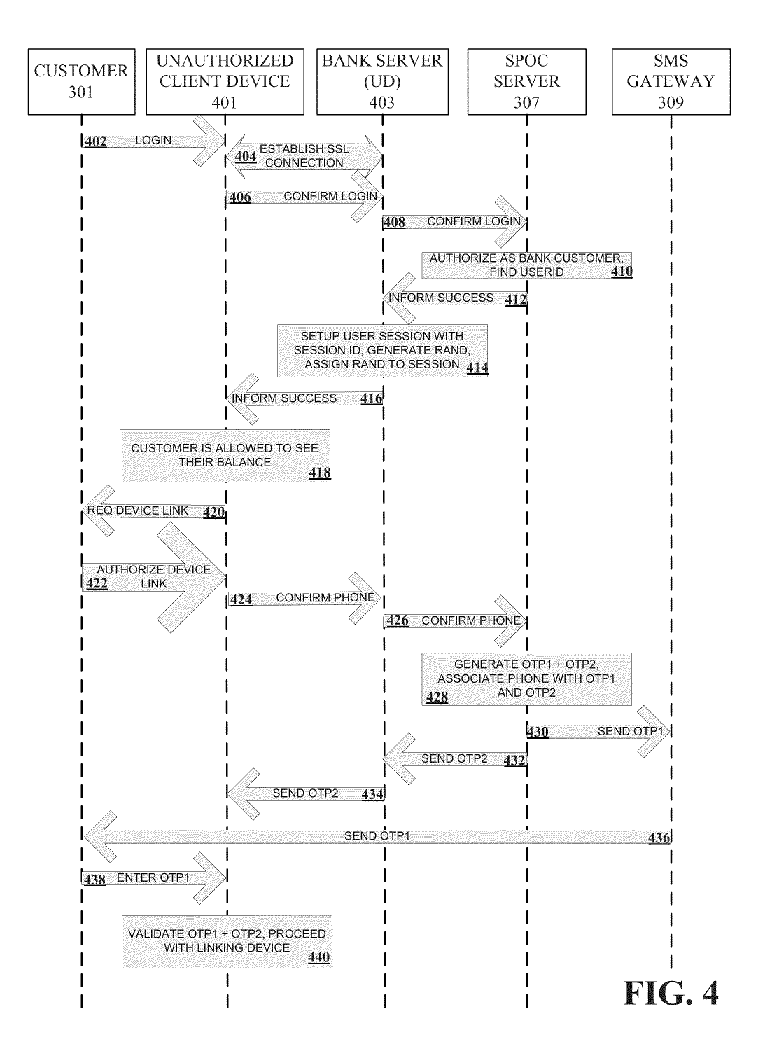

Referring now to FIG. 4, there is illustrated an example flow diagram method for authenticating a customer using an unauthorized device. Unauthorized client device 401 can be an internet browser or a mobile device without a device certificate. Bank server for unauthorized devices (“Bank Server (UD)”) 403 can be a mobile or web server accessed by a universal resource locator (“URL”) and that supports SSL connections for unauthenticated devices. At 402, customer 301 can login to unauthorized client device 401 by submitting login information, including for example, a username, a password, a personal identification number (“PIN”), answers to security questions, etc. At 404, unauthorized client device 401 can establish a secure connection with bank server (UD) 403 using, for example, an SSL protocol. At 406, unauthorized client device 401 can send the login information to bank server (UD) 403. At 408, bank server (UD) 403 can send the login information to SPOC server 307.

At 410, SPOC server 307 can authorize customer 301 as a registered bank customer based on the login information, and find their user id of customer 301. If the login information does not match a known bank customer, SPOC server 307 can inform bank server (UD) 403 which can inform unauthorized client device 401 that the user is not authenticated and the session can be terminated. If the login information does match a known bank customer, SPOC server 307 can send the user id to bank server (UD) 403 at 412. At 414, bank server (UD) 403 can establish a user session with a session id, generate a RAND to prevent a replay of the session as a client accessing the session would need to know RAND. RAND can then be assigned to the session id. At 416, the session id and RAND can be sent to unauthorized client device 401. At 418, customer 301 is logged in and can see the balance of any account he or she holds, but cannot perform banking operations.

In an alternate embodiment, Customer 301 can then be asked whether they wish to authorize the device. At 420, unauthorized client device 401 can display a query to the user asking him or her whether they wish to link the unauthorized client device 401 to their account. If customer 301 does not wish to link the device, the customer 301 continues to be able to see the balance of any account he or she holds, but cannot perform banking operations. If customer 301 affirms their desire to link the device 1t 422, then at 424, unauthorized client device 401 can send a request to confirm the customer phone along with the session id, to bank server (UD) 403. At 426, bank server (UD) 403 can send the request to confirm the customer phone along with the user id to SPOC server 307.

At 428, SPOC server 307 can generate a first one time password (“OTP1”) and a second one time password (“OTP2”) for phone validation, and associate the phone number associated with the user id with OTP1 and OTP2. At 430, OTP1 can be sent to SMS gateway 309. At 432, OTP2 can be sent to bank server (UD) 403. At 434, OTP2 can be sent to unauthorized client device 401. At 436, SMS gateway 309 can send OTP1 to the phone number associated with the user id via SMS text message. At 438, customer can enter OTP1 in to unauthorized client device 401. At 440, OTP1 and OTP2 can be validated. Upon validation, the remaining portions of the method depicted in FIG. 3, starting with step 336, can be used to complete the registration and linking of the device.

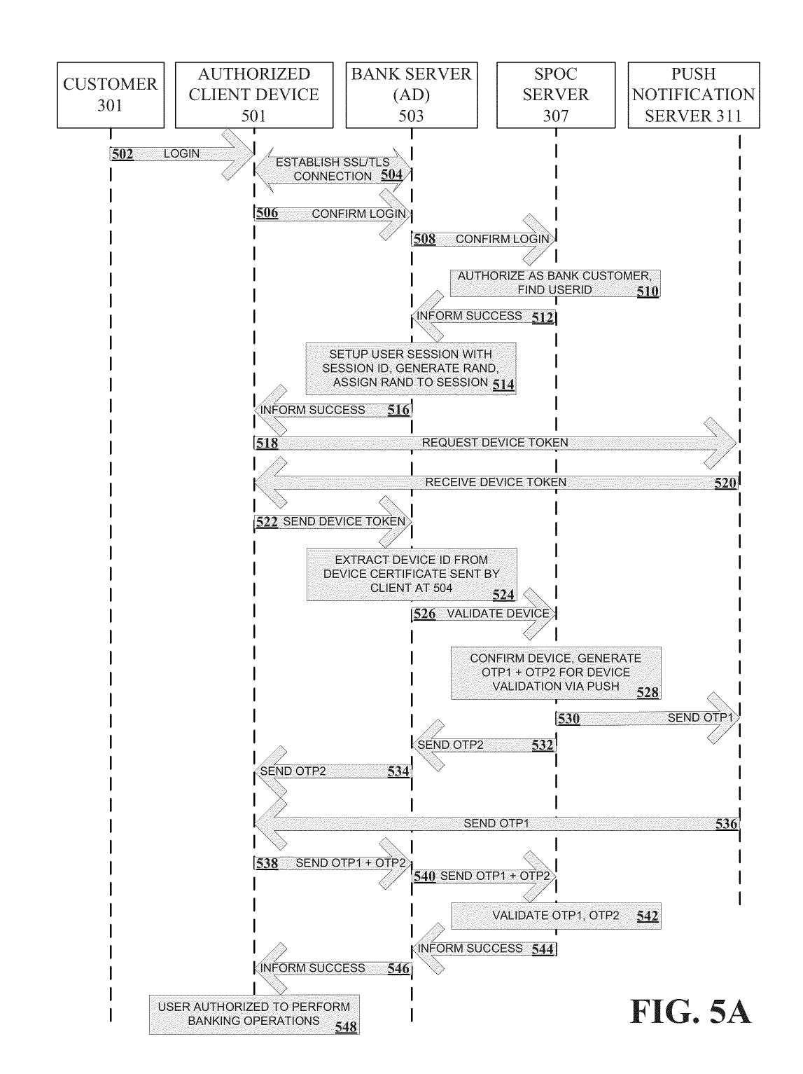

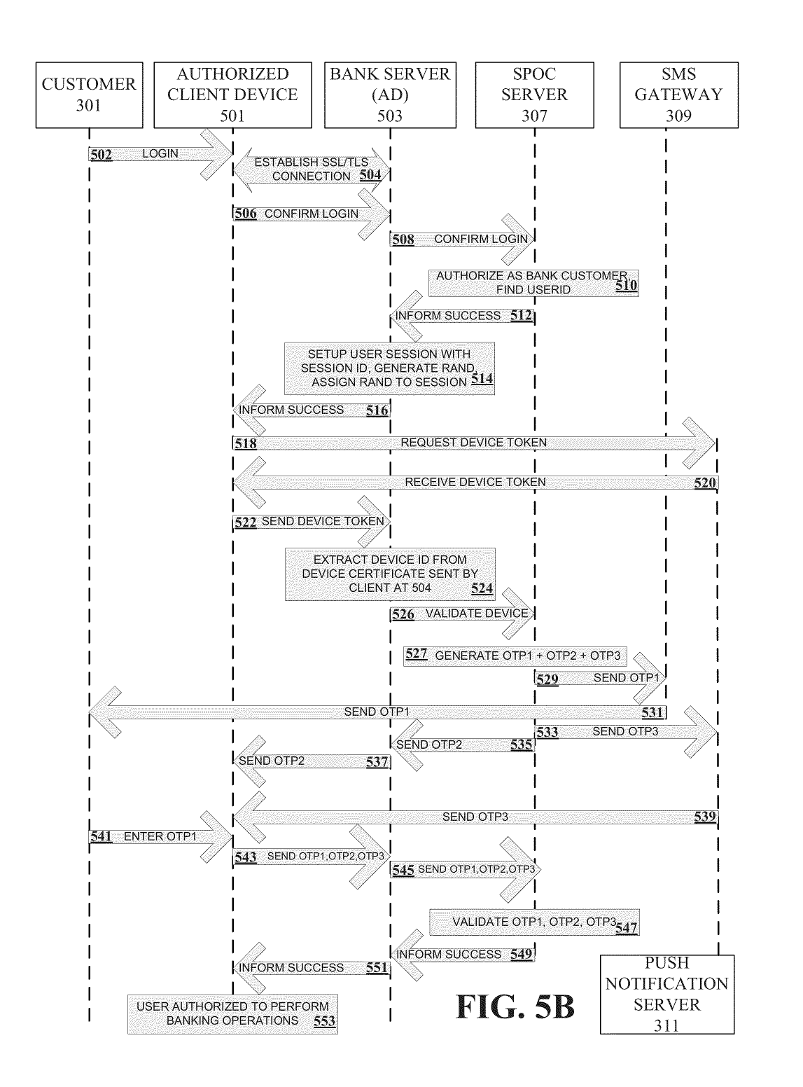

Referring now to FIG. 5A, there is illustrated an example flow diagram method for authenticating a customer using an authorized device with a valid device token. Authorized client device 501 can be an internet browser or a mobile device with a device certificate. Bank server for authorized devices (“bank server (AD)”) 503 can be a mobile or web server accessed by a universal resource locator (“URL”) and that supports TLS connections for unauthenticated devices.

At 502, customer 301 can login to authorized client device 501 by submitting login information, including for example, a username, a password, a personal identification number (“PIN”), answers to security questions, etc. At 504, authorized client device 501 can establish a secure connection with bank server (AD) 503 using, for example, a TLS protocol. An example TLS handshake protocol includes authorized client device 501 sending a TLS initiation to bank server (AD) 503. Bank server (AD) 503 can send a server certificate to authorized client device 501. Authorized client device 501 can validate the server certificate and in response send a device certificate stored in the memory of authorized client device 501 to bank server (AD) 503. Bank server (AD) 503 can validate the device certificate, and upon validation, a TLS can be established.

At 506, authorized client device 501 can send the login information to bank server (AD) 503. At 508, bank server (AD) 503 can send the login information to SPOC server 307. At 510, SPOC server 307 can authorize customer 301 as a registered bank customer based on the login information, and find their user id of customer 301. If the login information does not match a known bank customer, SPOC server 307 can inform bank server (AD) 503 which can inform authorized client device 501 that the user is not authenticated and the session can be terminated. If the login information does match a known bank customer, SPOC server 307 can send the user id to bank server (AD) 503 at 512. At 514, bank server (AD) 503 can establish a user session with a session id, generate a RAND to prevent a replay of the session as a client accessing the session would need to know RAND. RAND can then be assigned to the session id. At 516, the session id and RAND can be sent to authorized client device 501.

At 518, authorized client device 501 can request a device token from push notification server 311. It can be appreciated that the device token can be platform specific, for example, a device token recognized no matter what type of device authorized client device 501 actually is, e.g., a phone, an internet browser, etc. At 520, authorized client device can receive a device token from push notification server 520. At 522, authorized client device 501 can send the session id and the device token to bank server (AD) 503. At 524, bank server (AD) 503 can extract a device id from the device certificate sent by authorized client device 501 at 504 during the TLS handshake. At 526, bank server (AD) 503 can send the user id, device id and device token to SPOC server 307. At 528, SPOC server 528 can confirm that the device token received at 526 is registered for the device based on the user id and device id.

If the device token is valid, at 530, a first one time password (“OTP1”) and a second one time password (“OTP2”) can be generated for device validation. At 528, OTP1 can be sent to push notification server 311. At 532, OTP2 can be sent to bank server (AD) 503. At 534, OTP2 can be sent to authorized client device 501. At 536, push notification server 311 can send OTP1 to authorized client device 501. At 538, authorized client device can send the session id, OTP2 received at 534, OTP1 received at 536, and a device certificate associated with authorized client device 501 to bank server (AD) 503. At 540, bank server (AD) 503 can send the user id, OTP1, OTP2, and the device certificate to SPOC server 307. At 542, SPOC server 307 can validate OTP1, OTP2, and the device certificate received at 540 for accuracy based on OTP1 and OTP2 generated at 528. The device certificate can be checked for appropriate signature, revocation, and whether the certificate is registered to the profile of customer 301. If OTP1, OTP2, and the device certificate are not valid, customer 301 can be informed of a lack of authentication and customer 301 will be restricted to viewing account balances and not allowed to perform banking operations. If OTP1, OTP2, and the device certificate are valid, at 544, SPOC server 307 can inform bank server (AD) 503 of the success. At 546, bank server (AD) 503 can inform authorized client device 501 of the success. At 548, customer 301 is authorized to perform banking operations.

Referring now to FIG. 5B, there is illustrated an example flow diagram method for authenticating a customer using an unauthorized device with an invalid device token. Steps 502 through 526 remain the same as depicted in FIG. 5A. Step 527 continues the method as described in steps 502 through 526 for the situation when the device token sent to bank server (AD) 503 at 526 is invalid.

At 527, a first one time password (“OTP1”) a second one time password (“OTP2”) and a third one time password (“OTP3) are generated. At 529, SPOC server 307 sends OTP1 to SMS gateway 309. At 531, SMS gateway 309 sends OTP1 to customer 301 via SMS text message to a phone number associated with customer 301. At 533, SPOC server sends OTP3 to push notification server 311. At 535, SPOC gateway 307 sends OTP2 to bank server (AD) 503. At 537, bank server (AD) 503 sends OTP2 to authorized client device 501. At 539, push notification server 311 sends OTP3 to authorized client device 501.

At 541, customer 301 can enter OTP1 received via SMS message at 531 in authorized client device 501. If OTP1 is requested to be entered by authorized client device 501 without a request by customer 301 for device validation, a fraud attack can be reported. At 543, authorized client device can send OTP1 received at step 541, OTP2 received at step 537, and OTP3 received at step 539, along with a session id to bank server (AD) 503. At 545, bank server (AD) 503 can send the user id, OTP1, OTP2, and OTP3 to SPOC server 307. At 547, SPOC server 307 can validate OTP1, OTP2, and OTP3 for accuracy. If OTP1, OTP2, and OTP3 are not all valid, customer 301 can be informed of a lack of authentication and customer 301 will be restricted to viewing account balances and not allowed to perform banking operations. If OTP1, OTP2, and OTP3 are valid, at 549, SPOC server 307 can inform bank server (AD) 503 of the success. At 551, bank server (AD) 503 can inform authorized client device 501 of the success. At 553, customer 301 is authorized to perform banking operations.

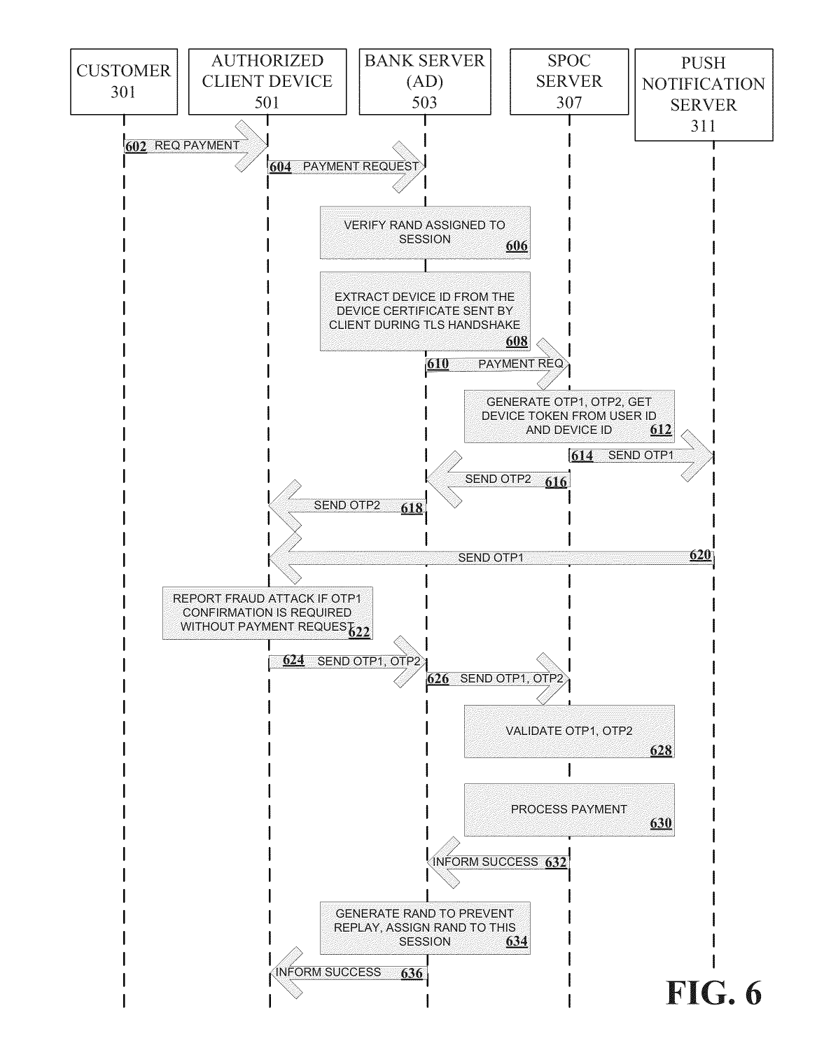

Referring now to FIG. 6, there is illustrated an example flow diagram method for performing banking operations using an authorized device. Authorized client device 501, in regards to the method shown in FIG. 6, has been authorized to perform banking operations within an ongoing valid active session with bank server (AD) 503, using, for example, the entire method as described in FIG. 5A, prior to step 602.

At 602, customer 301 makes a request to perform a banking operation using authorized client device 501. A banking operation can be a payment to a merchant, a funds transfer, a wire transfer, an online bill pay transaction, ordering additional banking products, closing an account, opening account, etc. At 604, the banking operation request along with the session id, and a RAND can be sent bank server (AD) 503. At 606, RAND can be verified that it is the RAND assigned to the session. If the RAND fails verification, the banking operation request will not be performed and customer 301 can be notified. If the RAND is verified, a device id can be extracted from the device certificate sent by authorized client device 501 during the TLS handshake as described in regards to step 504.

At 610, the request for banking operations, the user id, and the device id can be sent to SPOC server 307. At 612, a first one time password (“OTP1”) and a second one time password (“OTP2”) can be generated. SPOC server 307 can also acquire the device token based on the user id and the device id received at step 610. At 614, SPOC server 307 can send OTP1 and the device token to push notification server 311. At 616, SPOC server 307 can send OTP2 to bank server (AD) 503. At 618, bank server (AD) 503 can send OTP2 to authorized client device 501. At 620, push notification server 311 can send OTP1 to authorized client device 501.

At 622, if authorized client device 501 receives OTP1 from push notification server 311 without having previously submitted a request for banking operations as described in step 604, then a fraud notification can be made. A fraud notification could include a message or data packet sent to an information processing server that can be used to alert an administrator, a user, or governmental authority about potential fraudulent activities.

At 624, OTP1, OTP2 and the session id can be sent to bank server (AD) 503. At 626, OTP1, OTP2 and user id can be sent by bank server (AD) 503 to SPOC server 307. At 628, SPOC server 311 can validate the user id, OTP1, and OTP2 based on OTP1 and OTP2 generated at step 612. If OTP1 and OTP2, submitted by authorized client device 501 at 624, do not match OTP1 and OTP2 generated at 612, then the banking operation request will not be performed and customer 301 can be notified. If OTP1 and OTP2 are verified, at 630, the banking operation request can be performed by SPOC server 307. At 632, SPOC server 307 can return a banking operation result to bank server (AD) 503. At 634, a RAND can be generated and assigned to the session to prevent replay of the transaction. At 636, authorized client device 501 can be notified of the banking operation result.

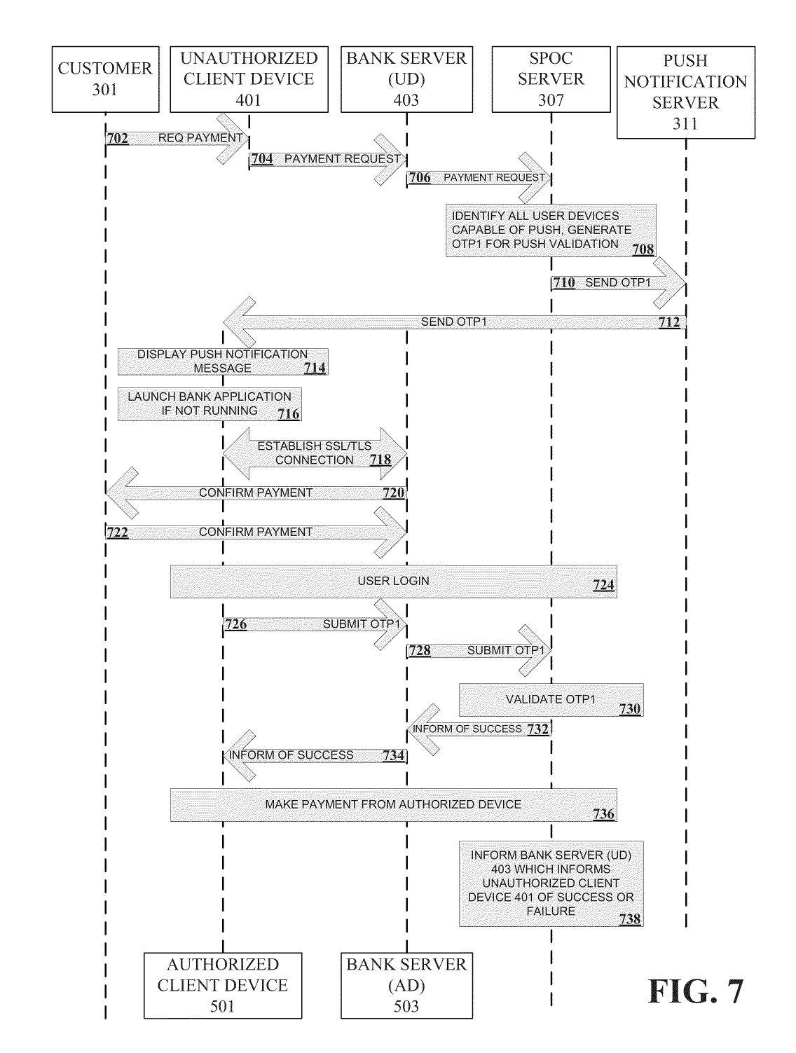

Referring now to FIG. 7, there is illustrated an example flow diagram method for performing banking operations using an unauthorized device. Unauthorized client device 401, in regards to the method shown in FIG. 7, has been authorized but not allowed to perform banking operations within an ongoing valid active session with bank server (UD) 403, using, for example, steps 402 through 418 of the method described in FIG. 4, prior to step 702.

At 702, customer 301 makes a request to perform a banking operation using unauthorized client device 401. A banking operation can be a payment to a merchant, a funds transfer, a wire transfer, an online bill pay transaction, ordering additional banking products, closing an account, opening account, etc. At 704, the banking operation request along with the session id can be sent bank server (UD) 403.

At 706, the banking operation request and a user id can be sent to SPOC server 307. At 708, SPOC server 307 can identify all user devices, e.g., authorized client devices, capable of push associated with the user id and generate a first one time password (“OTP1”) and associate OTP1 with the user id and the banking operation request. At 710, SPOC server 307 can send OTP1 to push notification server 311. At 712, push notification server 311 can send OTP1 to every user device identified at 708. The following steps can then be performed by any of the devices that receive OTP1; however, authorized client device 501 is depicted in the method as an example of a device. At 714, authorized client device 501 can display a push notification message to customer 301.

At 716, authorized client device 501 can launch a bank application if the application is not running. At 718, client device 501 can establish an SSL/TSL connection with bank server (AD) 503 as described by step 504 in regards to FIG. 5A. At 720, customer 301 can receive a request to confirm the banking operation request. At 722, customer 301 can confirm the banking operation request. If the request is not confirmed, customer 301 can be notified using unauthorized client device 401 that the banking operation request was rejected. At 724, customer 301 can login using steps 502 through 548 as described in regards to FIG. 5A.

At 726, authorized client device 501 can submit OTP1 received at step 712, a session id, and the banking operation request to bank server (AD) 503. At 728, bank server (AD) 503 can send OTP1, the user id, and the banking operation request to SPOC server 307. At 730, SPOC server 307 can validate OTP1 submitted at 728 for accuracy. At 732, SPOC server 307 can send the banking operation request to bank server (AD) 503. At 734, bank server (AD) 503 can send the banking operation request to authorized client device 501. At 736, steps 604 through 636 can performed to process a banking operation request from an authorized device. At 738, bank server (UD) 403 can be informed regarding the outcome of the banking operation request as processed at 736 and can inform unauthorized client device 401 regarding the success or failure of the performance of the banking operation request.

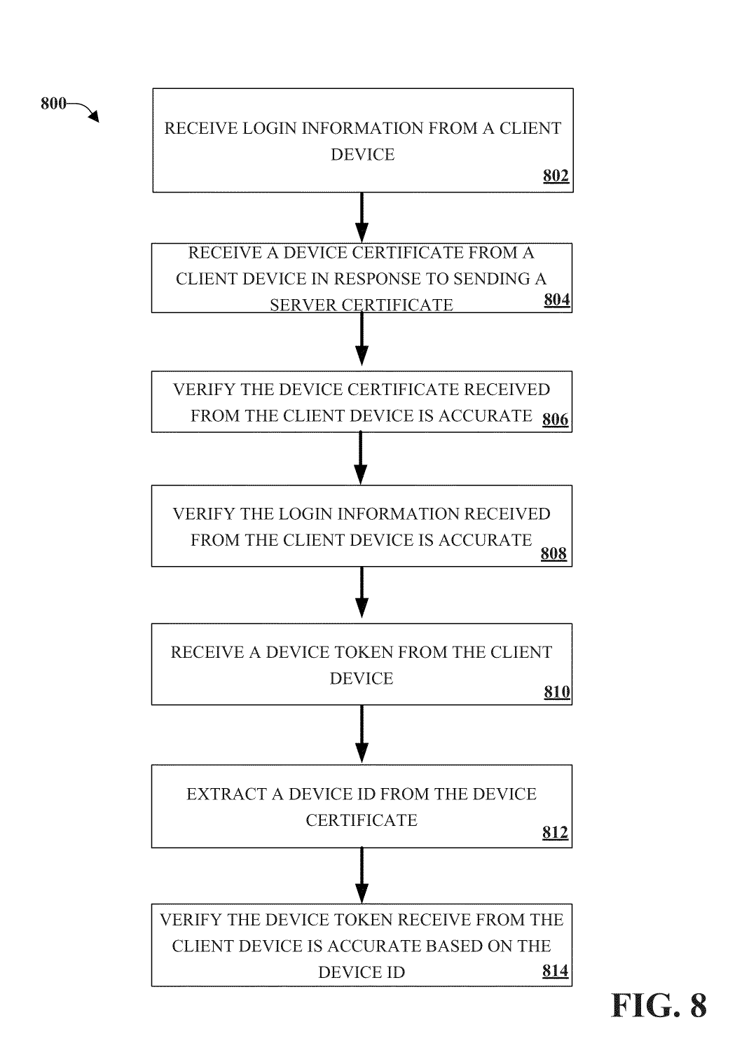

Referring now to FIG. 8, there is illustrated an example flow diagram method for authenticating a customer. At 802, login information can be received from a client device where login information can include, for example, a username, a password, a personal identification number (“PIN”), answers to security questions, etc. At 904, a device certificate can be received from the client device in response to sending a server certificate to the client device. At 806, the device certificate can be verified for accuracy. At 808, the login information can be verified for accuracy. At 810, a device token can be received from the client device. At 812, a device id can be extracted from the device certificate. At 814, the device token can be verified for accuracy based on the device id. For example, the device token can verified by matching the device ID extracted from the device certificate with the device token received at 810.

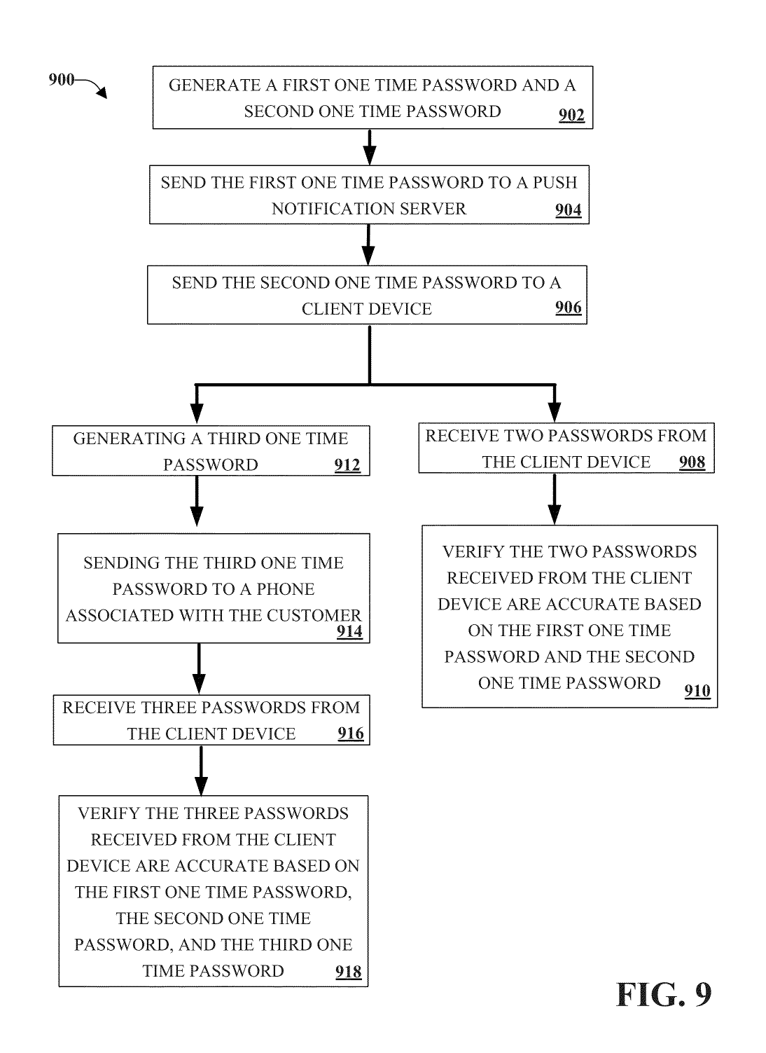

Referring now to FIG. 9, there is illustrated an example flow diagram method for authenticating a customer with both either a valid or an invalid device token. At 902, a first one time password and a second one time password can be generated. At 904, the first one time password can be sent to push notification server. At 906, the second one time password can be sent to a client device.

In one embodiment, for a client device with a valid device token, two one time passwords can be received from the client device at 908. At 910, the two passwords can be verified for accuracy based on the first one time password and the second one time password.

In one embodiment, for a client device with an invalid device token, a third one time password can be generated at 912. The third one time password can be sent to a phone associated with the customer. At 916, three passwords can be received from the client device. At 918, the passwords received at 916 can be compared to the first one time password, the second one time password, and the third one time password for accuracy.

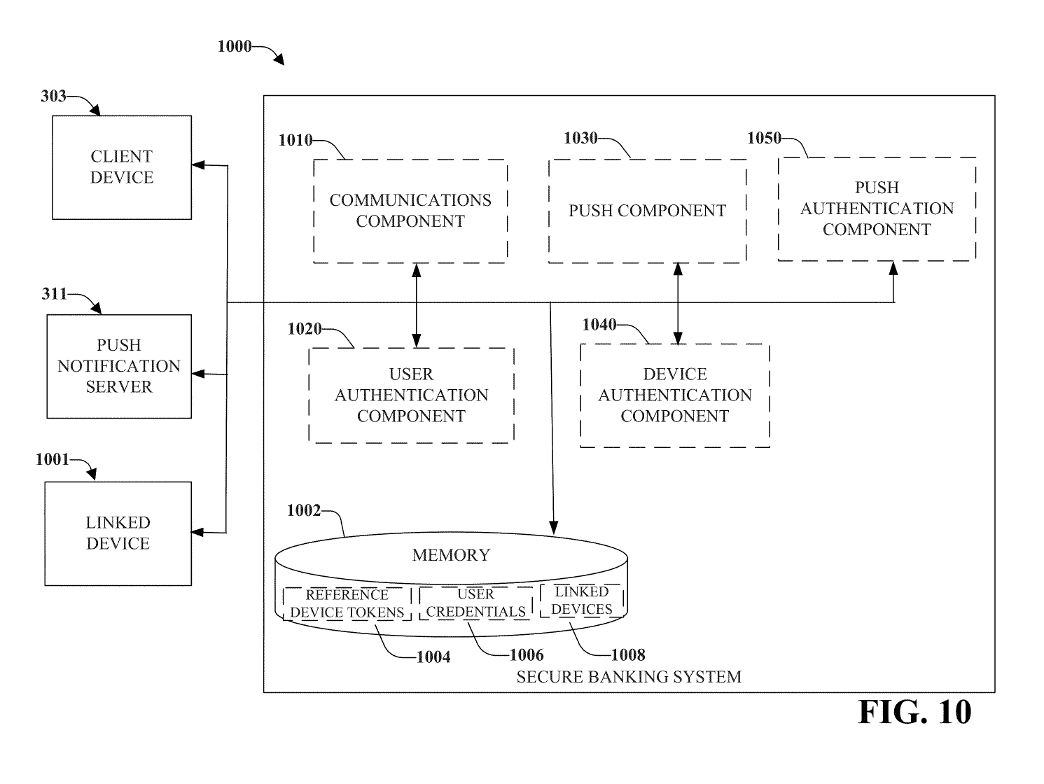

FIG. 10 illustrates an example secure banking system 1000 in accordance with the subject disclosure. A communications component 1010 can at least one of send or receive data packets to or from a client device 303. In one embodiment, communications component 1010 can at least one of send or receive data packets to or from linked device 1001 or push notification server 311. In another embodiment, communication component 1010 can at least one of send or receive data packets to or from the client device using a secure sockets layer protocol or a transport layer security protocol.

A user authentication component 1020 can receive and authenticate login information from the client device. Login information can include, for example, a username, a password, a personal identification number (“PIN”), answers to security questions, etc. User authentication component can use user credentials 1006 stored within memory 1002 in authenticating login information received from the client device. User credentials 1006 can be a database associating a username with passwords, PINs, security question answers, etc.

A push component 1030 can upon authentication of the login information send a push notification to a linked device associated with the login information. A push notification is a request initiated by push component 1030 rather than linked device 1001 wherein the push notification includes instructions that when received by linked device 1001, provides for the linked device to generate a push confirmation. In one embodiment, push component 1030 can send the push notification to push notification server 311 for delivery to the linked device 1001. Push component 1030 can identify a linked device associated with the login information using a set of linked device information 1008 stored within memory 1002. In one embodiment, linked device 1001 can be the same device as client device 303 if client device 303 is identified within linked devices 1008 as the linked device associated with the login information.

In one embodiment, push component 1030 can, upon request by the linked device 1001, send the device token associated with the linked device 1001 to the linked device 1001. Push component can use the set of reference device tokens 1004 stored within memory 1002 in identifying the device token associated with the linked device prior to sending the device token to the linked device 1001.

Device authentication component 1040 can receive and authenticate a device certificate and a device token from the client device. In on embodiment, device authentication component authenticates the device certificate and the device token based upon whether the device certificate and the device token are both associated with the same device. In another embodiment, device authentication component 1040 can extract a device id from the device certificate received from the client device 303 and use the device id extracted to determine a matching device token in the set of reference device tokens 1004 stored within memory 1002. Device authentication component 1040 can then compare the reference device token associated with the device id extracted from the device certificate to the received device token for accuracy.

In one embodiment, communication component 1010 can, in response to the device authentication component 1040 receiving an inaccurate device token, can send a message to the linked device associated with the login information. The message can be an email message, an SMS text message, a voicemail message, an automated phone call, etc. The message can contain a fraud alert that someone may be attempting to fraudulently access the customer's account.

Push authentication component 1050 can receive and authenticate a push confirmation from the client device. An authentic push confirmation should be associated with the push notification sent by push component 1030.

If the login information, the device certificate, the device token and the push confirmation are all authenticated by the user authentication component 1020, the device authentication component 1040 and the push authentication component 1050 respectively, then the client device is authorized to perform banking transactions.

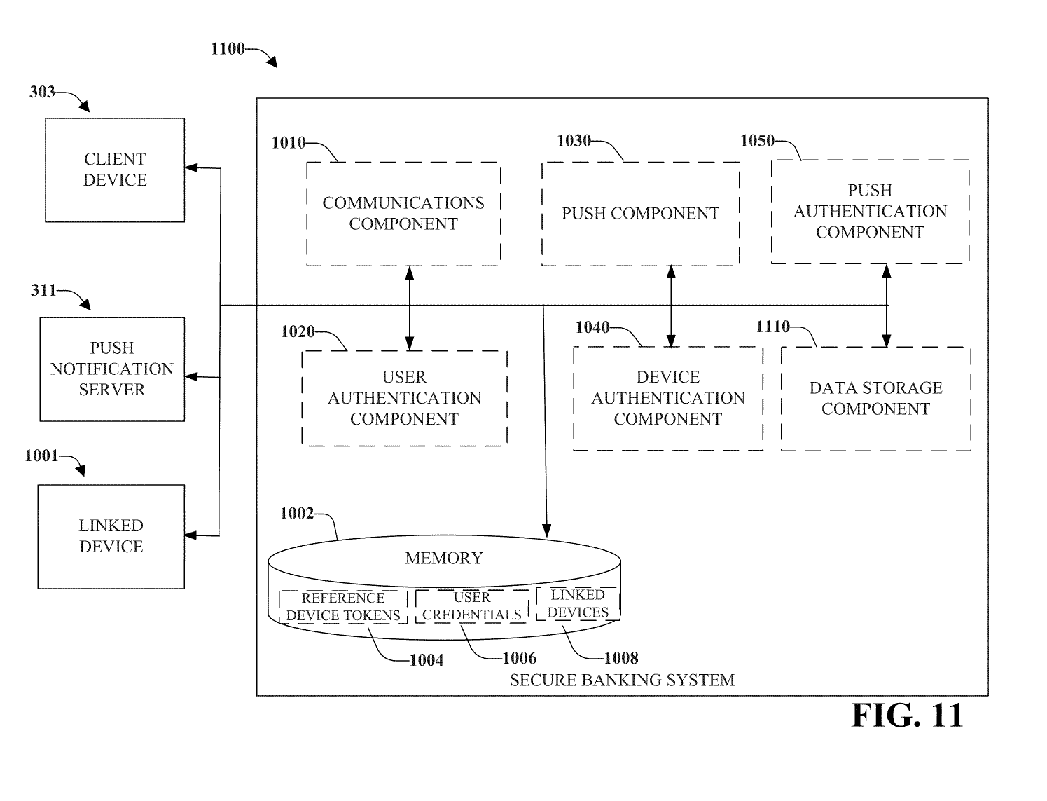

Referring now to FIG. 11, there is illustrated an example secure banking system 1100 including a data storage component 1110 in accordance with the subject disclosure. Data storage component 1110 can store a set of reference device tokens 1004 wherein each reference device token in the set of reference device tokens is associated with one linked device. It can be appreciated that data storage component 1110 can continuously update the set of reference device tokens 1004 stored within memory 1002. In one embodiment, data storage component 1110 can duplicate the set of reference device tokens or alternatively make accessible the set of reference device tokens 1004 stored within memory 1002 to push notification server 311.

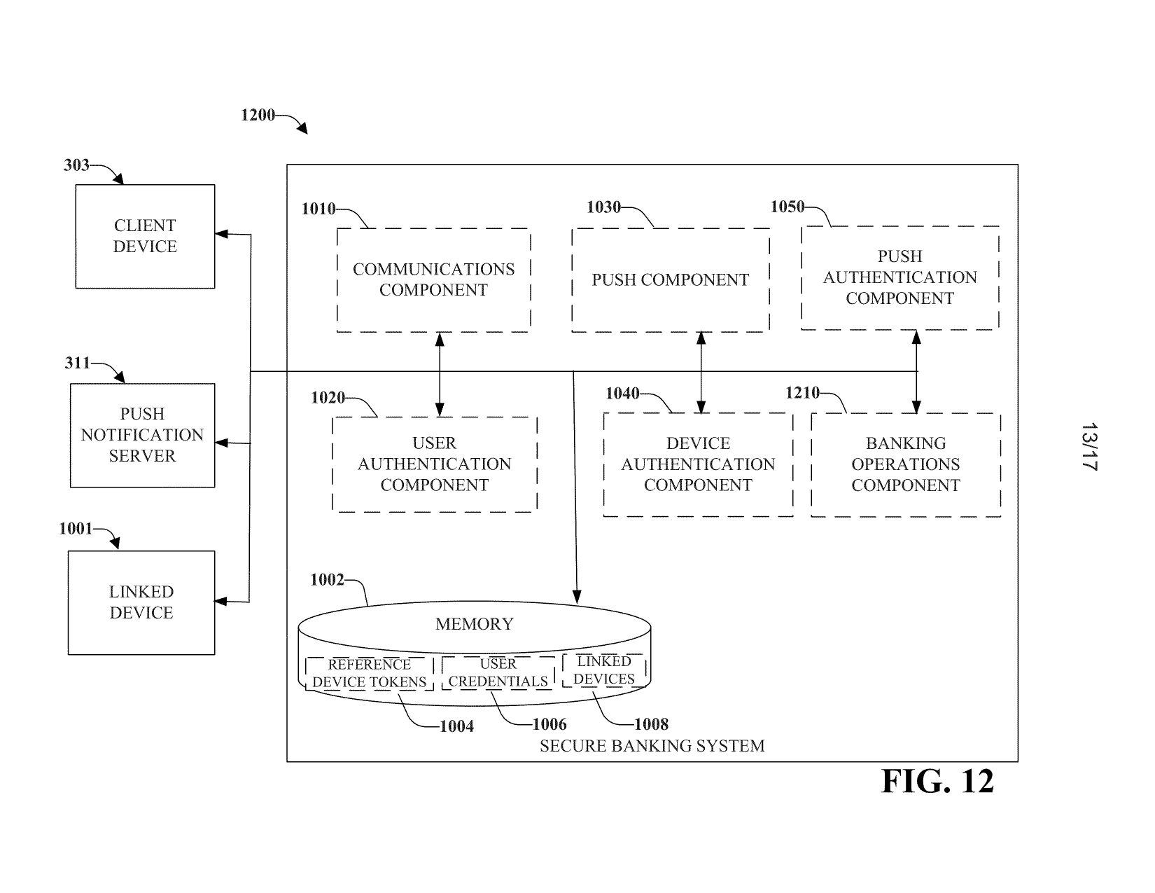

Referring now to FIG. 12, there is illustrated an example secure banking system 1200 including a banking operations component 1210 in accordance with the subject disclosure. Banking operation component can receive a banking operation request from the client device 303 and generate a first one time password and a second one time password wherein the push component 1030 can send the first one time password to the linked device 1001 associated with the login information and the communications component sends the second one time password to the client device. In one embodiment, push component 1030 can use push notification server 311 to send the first one time password to the linked device 1001 associated with the login information.

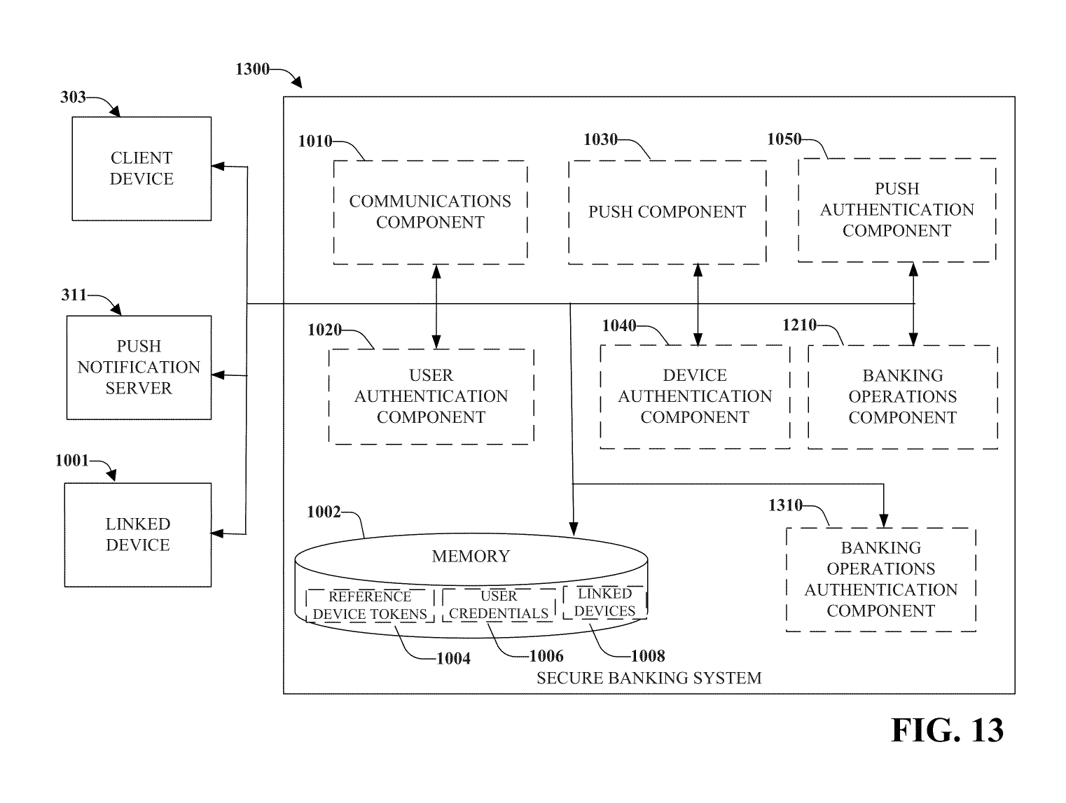

Referring now to FIG. 13, there is illustrated an example secure banking system 1300 including a banking operations authentication component 1310 in accordance with the subject disclosure. Banking operations authentication component 1310 can receive and authenticate two passwords from the client device, wherein upon authentication, the banking operation request is processed. In one embodiment, banking operations authentication component 1310 can authenticate the two passwords by comparing the two passwords to the first one time password and the second one time password.

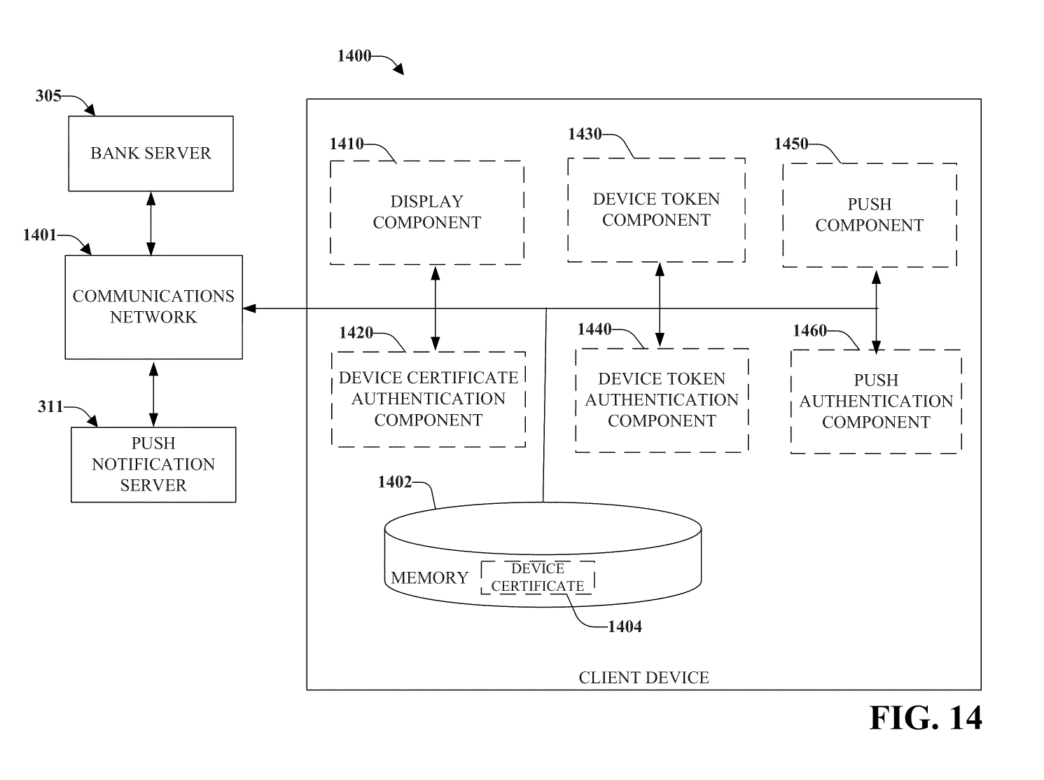

FIG. 14 illustrates an example client device 1400 in accordance with the subject disclosure. The client device 1400 can contain at least one memory that stores computer executable components and a processor that facilitates execution of one or more computer executable components stored within the memory. A display component 1410 can display a user request wherein the display component 1410 further receives login information from a user based on the user request. In one embodiment, display component 1410 can further receive a banking operation request based on the user request.

A device certificate authentication component 1420 can send a device certificate to a bank server 305 using a communications network 1401 and receive confirmation from the bank server 305 using the communications network 1401 that the device certificate is valid. In one embodiment, device certificate authentication component 1420 can send the device certificate 1404 stored within memory 1402 of client device 400. In one embodiment, the device certificate authentication component 1420 can send the device certificate to the bank server 305 using communications network 1401 and receive confirmation from the bank server using a transport layer security (“TLS”) protocol.

A device token component 1430 can send a device token request to a push notification server 311 using the communications network 1401 and receive a device token from the push notification server 311 using the communications network 1401 based upon the device token request. A device token authentication component 1440 can send the device token to the bank server 305 using the communications network 1401 and receive confirmation from the bank server 305 using the communications network 1401 that the device token is valid.

A push component 1450 can receive a first one time password from the bank server 305 using the communication network 1401 and a second one time password from the push notification server 311 using the communications network 1401. A push authentication component 1460 can send the first one time password and the second one time password to the bank server 305 using the communications network 1401 and receive confirmation from the bank server 305 using the communications network 1401 that the first one time password and the second one time password are valid.

If the device certificate, the device token, the first one time password, and the second one time password are valid, the user of client device 1400 is authorized to perform banking transactions.

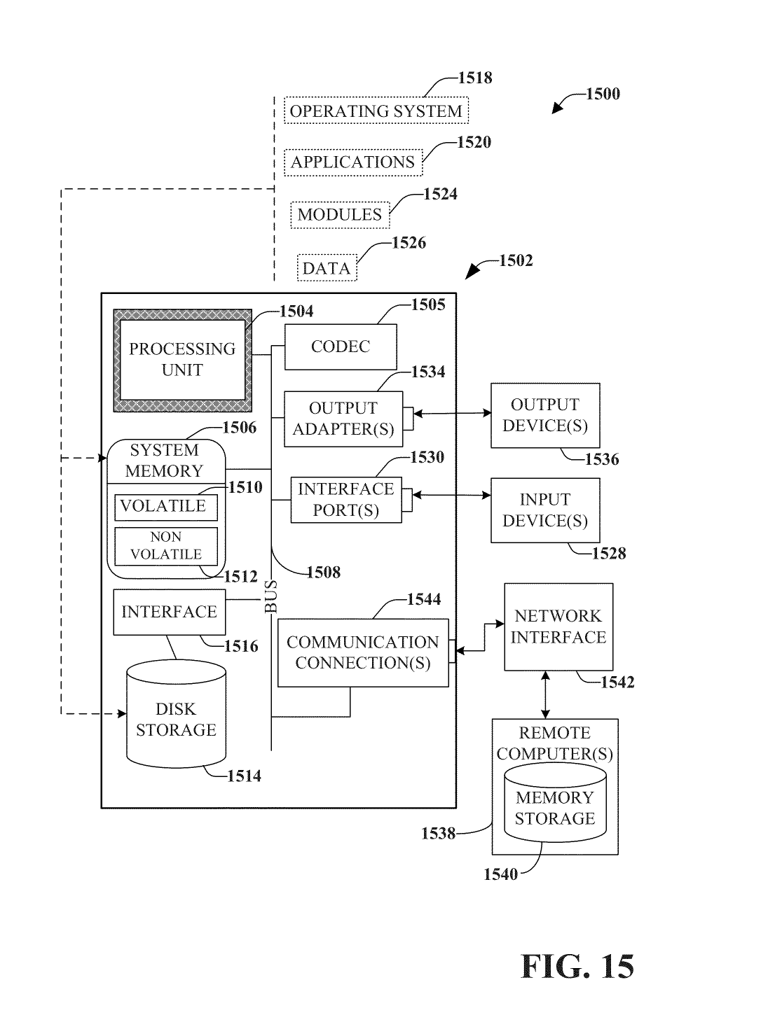

With reference to FIG. 15, a suitable environment 1500 for implementing various aspects of the claimed subject matter includes a computer 1502. The computer 1502 includes a processing unit 1504, a system memory 1506, a codec 1505, and a system bus 1508. The system bus 1508 couples system components including, but not limited to, the system memory 1506 to the processing unit 1504. The processing unit 1504 can be any of various available processors. Dual microprocessors and other multiprocessor architectures also can be employed as the processing unit 1504.

The system bus 1508 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1506 includes volatile memory 1510 and non-volatile memory 1512. The basic input/output system (BIOS), containing the basic routines to transfer information between elements within the computer 1502, such as during start-up, is stored in non-volatile memory 1512. By way of illustration, and not limitation, non-volatile memory 1512 can include read only memory (ROM), programmable ROM (PROM), electrically programmable ROM (EPROM), electrically erasable programmable ROM (EEPROM), or flash memory. Volatile memory 1510 includes random access memory (RAM), which acts as external cache memory. According to present aspects, the volatile memory may store the write operation retry logic (not shown in FIG. 15) and the like. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM).

Computer 1502 may also include removable/non-removable, volatile/non-volatile computer storage media. FIG. 15 illustrates, for example, a disk storage 1514. Disk storage 1514 includes, but is not limited to, devices like a magnetic disk drive, solid state disk (SSD) floppy disk drive, tape drive, Jaz drive, Zip drive, LS-100 drive, flash memory card, or memory stick. In addition, disk storage 1514 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1514 to the system bus 1508, a removable or non-removable interface is typically used, such as interface 1516.

It is to be appreciated that FIG. 15 describes software that acts as an intermediary between users and the basic computer resources described in the suitable operating environment 1500. Such software includes an operating system 1518. Operating system 1518, which can be stored on disk storage 1514, acts to control and allocate resources of the computer system 1502. Applications 1520 take advantage of the management of resources by operating system 1518 through program modules 1524, and program data 1526, such as the boot/shutdown transaction table and the like, stored either in system memory 1506 or on disk storage 1514. It is to be appreciated that the claimed subject matter can be implemented with various operating systems or combinations of operating systems.

A user enters commands or information into the computer 1502 through input device(s) 1528. Input devices 1528 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1504 through the system bus 1508 via interface port(s) 1530. Interface port(s) 1530 include, for example, a serial port, a parallel port, a game port, and a universal serial bus (USB). Output device(s) 1536 use some of the same type of ports as input device(s) 1528. Thus, for example, a USB port may be used to provide input to computer 1502, and to output information from computer 1502 to an output device 1536. Output adapter 1534 is provided to illustrate that there are some output devices 1536 like monitors, speakers, and printers, among other output devices 1536, which require special adapters. The output adapters 1534 include, by way of illustration and not limitation, video and sound cards that provide a means of connection between the output device 1536 and the system bus 1508. It should be noted that other devices and/or systems of devices provide both input and output capabilities such as remote computer(s) 1538.

Computer 1502 can operate in a networked environment using logical connections to one or more remote computers, such as remote computer(s) 1538. The remote computer(s) 1538 can be a personal computer, a bank server, a bank client, a bank processing center, a certificate authority, a router, a network PC, a workstation, a microprocessor based appliance, a peer device, a smart phone, a tablet, or other network node, and typically includes many of the elements described relative to computer 1502. For purposes of brevity, only a memory storage device 1540 is illustrated with remote computer(s) 1538. Remote computer(s) 1538 is logically connected to computer 1502 through a network interface 1542 and then connected via communication connection(s) 1544. Network interface 1542 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1544 refers to the hardware/software employed to connect the network interface 1542 to the bus 1508. While communication connection 1544 is shown for illustrative clarity inside computer 1502, it can also be external to computer 1502. The hardware/software necessary for connection to the network interface 1542 includes, for exemplary purposes only, internal and external technologies such as, modems including regular telephone grade modems, cable modems and DSL modems, ISDN adapters, and wired and wireless Ethernet cards, hubs, and routers.

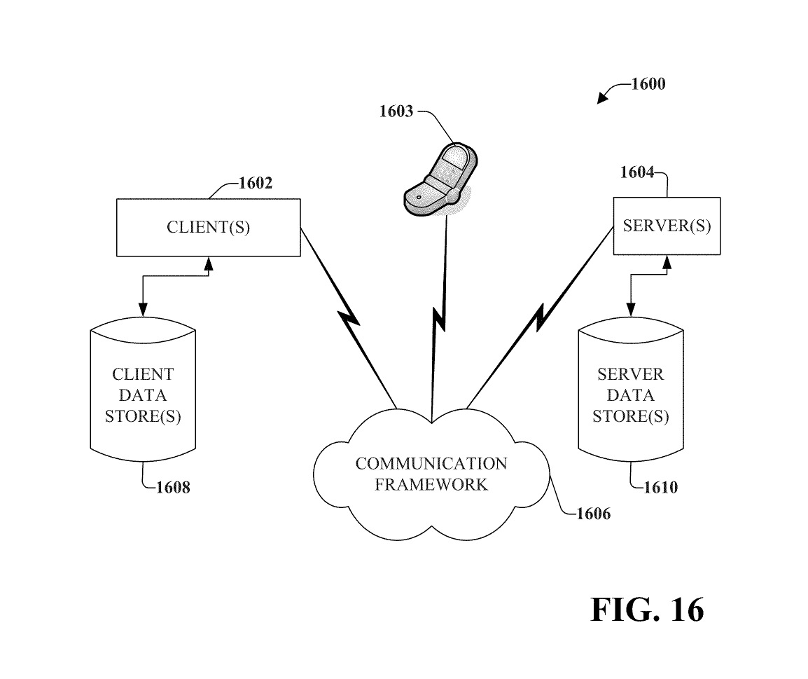

Referring now to FIG. 16, there is illustrated a schematic block diagram of a computing environment 1600 in accordance with the subject specification. The system 1600 includes one or more client(s) 1602, which can include an application or a system that accesses a service on the server 1604. The client(s) 1602 can be hardware and/or software (e.g., threads, processes, computing devices). The client(s) 1602 can house cookie(s) and/or associated contextual information by employing the specification, for example.

The system 1600 also includes one or more server(s) 1604. The server(s) 1604 can also be hardware or hardware in combination with software (e.g., threads, processes, computing devices). The servers 1604 can house threads to perform, for example, device id extraction, authentication, verification, etc. One possible communication between a client 1602 and a server 1604 can be in the form of a data packet adapted to be transmitted between two or more computer processes where the data packet contains, for example, a certificate. The data packet can include a cookie and/or associated contextual information, for example. The system 1600 includes a communication framework 1606 (e.g., a global communication network such as the Internet) that can be employed to facilitate communications between the client(s) 1602 and the server(s) 1604.

Communications can be facilitated via a wired (including optical fiber) and/or wireless technology. The client(s) 1602 are operatively connected to one or more client data store(s) 1608 that can be employed to store information local to the client(s) 1602 (e.g., cookie(s) and/or associated contextual information). Similarly, the server(s) 1604 are operatively connected to one or more server data store(s) 1610 that can be employed to store information local to the servers 1604.

The illustrated aspects of the disclosure may also be practiced in distributed computing environments where certain tasks are performed by remote processing devices that are linked through a communications network. In a distributed computing environment, program modules can be located in both local and remote memory storage devices.

The processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

What has been described above includes examples of the implementations of the present invention. It is, of course, not possible to describe every conceivable combination of components or methods for purposes of describing the claimed subject matter, but many further combinations and permutations of the subject embodiments are possible. Accordingly, the claimed subject matter is intended to embrace all such alterations, modifications, and variations that fall within the spirit and scope of the appended claims. Moreover, the above description of illustrated implementations of this disclosure, including what is described in the Abstract, is not intended to be exhaustive or to limit the disclosed implementations to the precise forms disclosed. While specific implementations and examples are described herein for illustrative purposes, various modifications are possible that are considered within the scope of such implementations and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the various embodiments includes a system as well as a computer-readable storage medium having computer-executable instructions for performing the acts and/or events of the various methods of the claimed subject matter.

What is claimed is:

1. A secure banking system comprising:
a memory that stores computer executable components; and
a processor that facilitates execution of computer executable components stored within the memory, the computer executable components, comprising:
a communications component that at least one of sends or receives data packets to or from a client device;
a user authentication component that receives and authenticates login information from the client device;
a push component that upon authentication of the login information sends a push notification to a linked device associated with the login information;
a device authentication component that receives and authenticates a device certificate and a device token from the client device;
a push authentication component that receives and authenticates a push confirmation from the client device;
wherein if the login information, the device certificate, the device token, and the push confirmation are authenticated, the client device is authorized to perform banking transactions.

2. The secure banking system of claim 1, further comprising:
a data storage component that stores a set of reference device tokens wherein each reference device token in the set of reference device tokens is associated with one linked device.

3. The secure banking system of claim 2, wherein the push component, upon request by the linked device, sends the device token associated with the linked device to the linked device.

4. The secure banking system of claim 1, wherein the communications component at least one of sends or receives data packets to or from the client device using a transport layer security (“TLS”) protocol.

5. The secure banking system of claim 1, wherein the device authentication component authenticates the device certificate and the device token based upon whether the device certificate and the device token are both associated with the same device.

6. The secure banking system of claim 1, wherein the communications component, in response to the device authentication component receiving an inaccurate device token, sends a message to the linked device associated with the login information.

7. The secure banking system of claim 6, wherein the message is an SMS text message.

8. The secure banking system of claim 6, wherein the message contains a fraud alert.

9. The secure banking system of claim 1, further comprising:
A banking operations component that receives a banking operation request from the client device and generates a first one time password and a second one time password wherein the push component sends the first one time password to the linked device associated with the login information and the communications component sends the second one time password to the client device.

10. The secure banking system of claim 9, further comprising:
a banking operations authentication component that receives and authenticates two passwords from the client device wherein upon authentication, the banking operation request is processed.

11. The secure banking system of claim 10, wherein the banking operations authentication component authenticates the two passwords by comparing the two passwords to the first one time password and the second one time password.

12. A client device, comprising:
at least one memory that stores computer executable components; and
a processor that facilitates execution of one or more computer executable components stored within the memory, the one or more computer executable components comprising:
a display component that displays a user request wherein the display component further receives login information from a user based on the user request;
a device certificate authentication component that sends a device certificate to a bank server using a communications network and receives confirmation from the bank server using the communications network that the device certificate is valid;
a device token component that sends a device token request to a push notification server using the communications network and receives a device token from the push notification server using the communications network based upon the device token request;
a device token authentication component that sends the device token to the bank server using the communications network and receives confirmation from the bank server using the communications network that the device token is valid;
a push component that receives a first one time password from the bank server using the communication network and a second one time password from the push notification server using the communications network;
a push authentication component that sends the first one time password and the second one time password to the bank server using the communications network and receives confirmation from the bank server using the communications network that the first one time password and the second one time password are valid;
wherein if the device certificate, the device token, the first one time password, and the second one time password are valid, the user is authorized to perform banking transactions.

13. The client device of claim 12, wherein the device certificate authentication component sends the device certificate to the bank server and receives confirmation from the bank server using a transport layer security (“TLS”) protocol.

14. The client device of claim 12, wherein the display component further receives a banking operation request based on the user request.

15. A method, comprising:
receiving, by at least one computing device including at least one processor, login information from a client device associated with a customer;
receiving a device certificate from the client device in response to sending a server certificate to the client device;
verifying the device certificate received from the client device is accurate;
verifying the login information received from the client device is accurate;
receiving a device token from the client device;
extracting a device id from the device certificate; and
verifying the device token received from the client device is accurate based on the device id.

16. The method of claim 15, wherein receiving the device certificate from the client device in response to sending a server certificate to the client device using a transport layer security (“TLS”) protocol.

17. The method of claim 15, further comprising:
generating a first one time password and a second one time password;
sending the first one time password to a push notification server; and
sending the second one time password to the client device;

18. The method of claim 17, further comprising:
receiving two passwords from the client device; and
verifying the two passwords received from the client device are accurate based on the first one time password and the second one time password.

19. The method of claim 17, further comprising:
generating a third one time password;
sending the third one time password to a phone associated with the customer;
receiving three password from the client device; and
verifying the three passwords received from the client device are accurate based on the first one time password, the second one time password, and the third one time password.

20. The method of claim 19, wherein in response to the verifying the three passwords received from the client device are accurate, sending a message to the client device containing a fraud alert.
